(19) United States
(12) Patent Application Publication
(10) Pub. No.: US 2013/0281202 A1
(43) Pub. Date: Oct. 24, 2013

(54) METHOD AND APPARATUS FOR PROVIDING GAME ELEMENTS IN A SOCIAL GAMING ENVIRONMENT

(71) Applicant: ZYNGA, INC., San Francisco, CA (US)

(72) Inventors: Vinh TRINH, Lutherville, MC (US); Paul STEPHANOUK, Phoenix, MD (US)

(21) Appl. No.: 13/865,333

(22) Filed: Apr. 18, 2013

Related U.S. Application Data
(60) Provisional application No. 61/635,099, filed on Apr. 18, 2012.

(51) Int. Cl. A63F 13/00

(52) U.S. Cl. CPC A63F 13/00
USPC 463/29

(57) ABSTRACT

A participant who has been designated as a friend (e.g., through a social networking application) is able to provide assistance to a user while the user is playing his/her game. A live board display area associated with the game includes game elements that have been provided by one or more friends to the user. The user is able to play the provided game element(s) into the game that he/she is currently playing.

### CROSS-REFERENCE TO RELATED APPLICATIONS

This application claims priority to U.S. Provisional Patent Application Ser. No. 61/635,099, filed Apr. 18, 2012, the disclosure of which is herein incorporated by reference in its entirety.

### FIELD OF THE INVENTION

The present invention pertains to gaming in a networked environment. More particularly, the present invention pertains to providing and receiving assistance from other players of a game based on, e.g., their participation in the game and ways for improving the play of a game.

### BACKGROUND OF THE INVENTION

There are a variety of social networking games available to the public at this time. Assignee of the present invention, Zynga Inc., has provided a number of such games where a user plays the game and is able to give and receive assistance to other players who are playing their own version of the game. For example, in the game FarmVille, a first user may accomplish some achievement that results in the ability to provide a game element (e.g., a gift of game currency) to another user of the game. In this example, the other user is a confirmed “friend” of the first user through a social networking website such as Facebook.

There is a need in the art to improve how assistance is provided between users of a game, especially in a social networking game environment.

### BRIEF DESCRIPTION OF THE DRAWINGS

FIG. 1 is an image display of a generic game including a live board feature according to an embodiment of the present invention.

FIG. 2 is an image display of a generic game including a live board feature according to an embodiment of the present invention.

FIG. 3 is an image display of a generic game including a live board feature according to an embodiment of the present invention.

FIG. 4 shows an exemplary architecture for implementing an embodiment of the present invention

### DETAILED DESCRIPTION

According to an embodiment of the present invention, a board that may be integrated into the display of a game and provide a manner for allowing other individuals to assist in the game play of a user. As used herein, the term “live board” refers to any of a number of embodiments of the present invention that provide a display of the assistance that these other individuals are providing. In embodiments of the present invention, the assistance is provided by a participant to a user if that participant has met at least one requirement of at least one game parameter with respect to a game application. The frequency of the assistance may be anywhere from a rare occurrence to continuous. In one embodiment, game play by a user requires this assistance from one or more other participants.

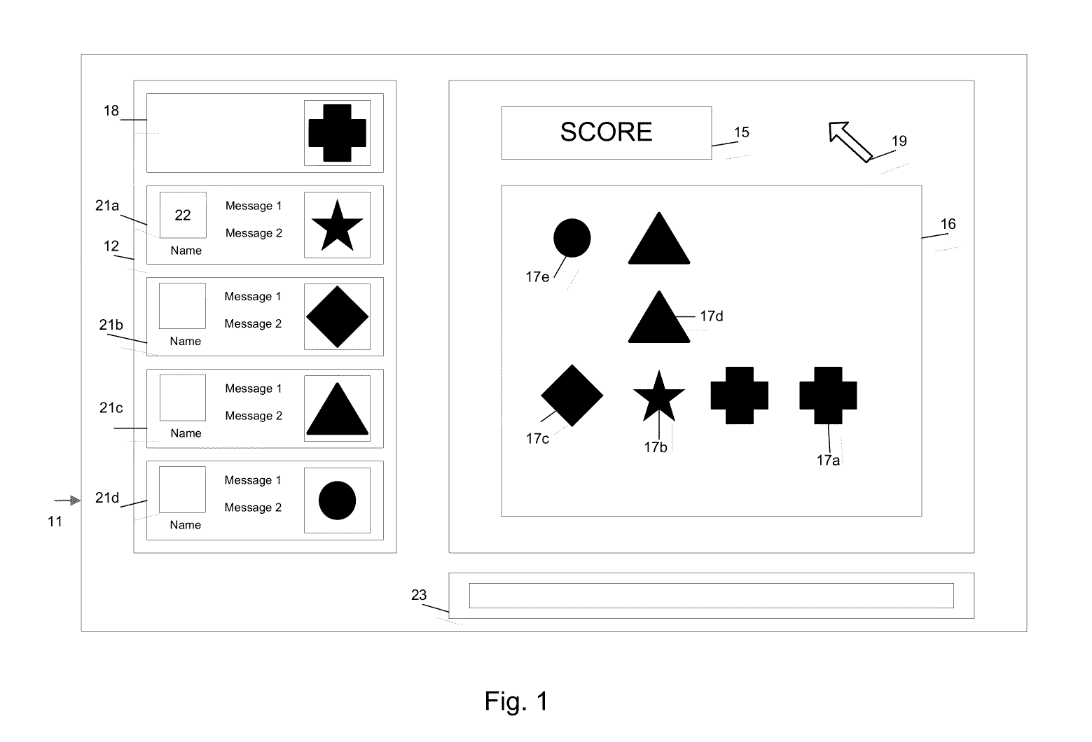

Referring to FIG. 1, an image display of a generic game including a live board feature of an embodiment of the present invention is shown. As seen in FIG. 1, a display 11 includes an assistance section or live board 12. A game area 14 is provided that includes an area 15 for displaying a score and a game play area or game board 16. Any of a variety of different games may be played on game board 16. In this example, the game is a simple, generic game involving a number of game pieces or tiles 17 a-e. In this embodiment, the next tile to be played is displayed in area 18 and is similar to tile 17a. In playing the game, the user would select this tile with a cursor movement device (not shown) controlling cursor 19 and place the tile in the game board 16. Once this is completed, the next game piece to be played, according to the game, would be displayed in area 18. As used herein, the term “user” refers to the individual or group that is playing the game shown in FIGS. 1-3 and is able to receive assistance via the live board 12 from one or more other game participants, referred to as “friends.”

According to an embodiment of the present invention, other individuals may assist the user by providing a game element. For example, other individuals may provide a game piece to the user that may be the same or different than the next game piece to be played in area 18. These other individuals may provide game pieces to the user in the live board 12 as described in further detail below. As seen in FIG. 1, it is possible that the user may not want to play the game piece that is shown in area 18 and would prefer to play a different game piece into game board 16.

In a social gaming environment, multiple participants may be playing his/her own version of the game on his/her own game board. Alternatively, multiple participants may be playing the same game from multiple locations (i.e., each participant would see the same game board that is shown, for example in game board 16 of FIG. 1). According to an embodiment of the present invention, friends of a user can provide assistance for game play of the user based on a variety of different factors as described below. The concept of coordinating with friends playing the same game (or their own individual versions of the game) appears in many games distributed by Zynga Inc. such as FarmVille and the Pioneer Trail. In these games, the potential “friends” may be those individuals who are a participant's friends in the Facebook social networking application. For example, a user of the game described in FIG. 1 may request a friend on Facebook to sign up for and play the same game (e.g., an invitation from one participant that is accepted by another).

After a friend connection has been made between a user and one or more of his/her Facebook friends for a game or set of games, a friend may provide assistance to the user playing the game in the live board 12. Based on a requirements of one or more parameters associated with a game, another participant may provide a game element (such as a game tile) to the user, which the user may use in the game board 16 that he/she is currently playing on. For example, if the friend has achieved a particular score in the game that he/she is playing, that friend may be allowed to provide a tile to the user. As shown in FIG. 1, several friends of the user are able to provide a game tile to the user. In this example, information about a first friend may be found in area 21a of the live board 12. Area 21a may include an image 22, such as a photographic image, of the friend, an icon that is used to represent the friend in this type of environment, etc. The name of the friend may be displayed below the image 22. One or more messages may also be provided. For example, the first message (i.e., Message 1) may be a description of the assistance that the friend is providing to the user along with any limitations that may be assigned to that assistance (e.g., the first five individuals that accept the game tile, further discussed below). The second message (i.e., Message 2) may be a personal message that the friend has provided to the user (e.g., through typing text at a keyboard into text-entry space 23 of the friend's computer. Fewer or more messages may be provided in the live board 12 as needed. The area 21a also includes a game tile that is being provided by the friend. In the example of FIG. 1, four friends of the user have the ability to provide a game tile to the user.

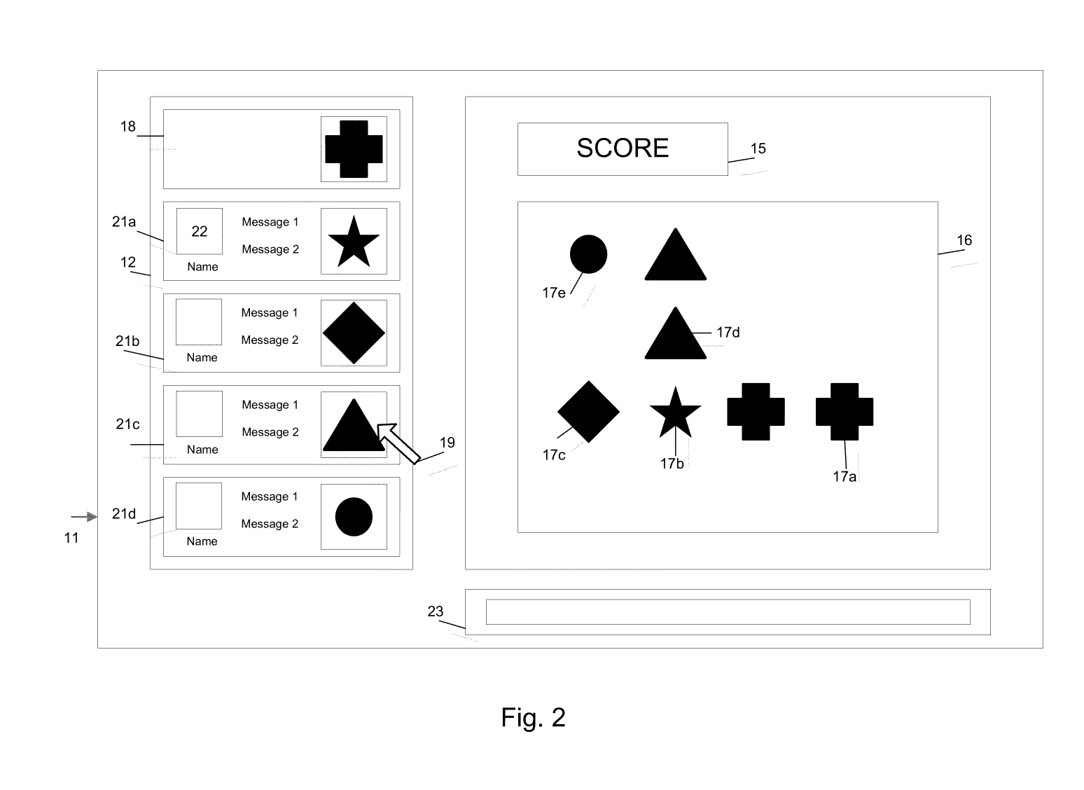

In FIG. 2, the user is playing the game on game board 16. For example, the user's previous play may have been to place game tile 17e in the position shown in FIG. 2. Absent assistance from any of the user's friends, the next game tile to be played is shown in area 18 in this example. As indicated in the description of FIG. 1, four friends of the user have each provided a game tile to the user. When one or more tiles are available, the user is able to optionally select a provided game tile (i.e., in areas 21a-d) rather than the normal, next game tile provided in area 18. Accordingly, the user manipulates cursor 19 using any of a variety of known manners to select a provided game tile (e.g., the game tile appearing in area 21c) to be played in game board 16.

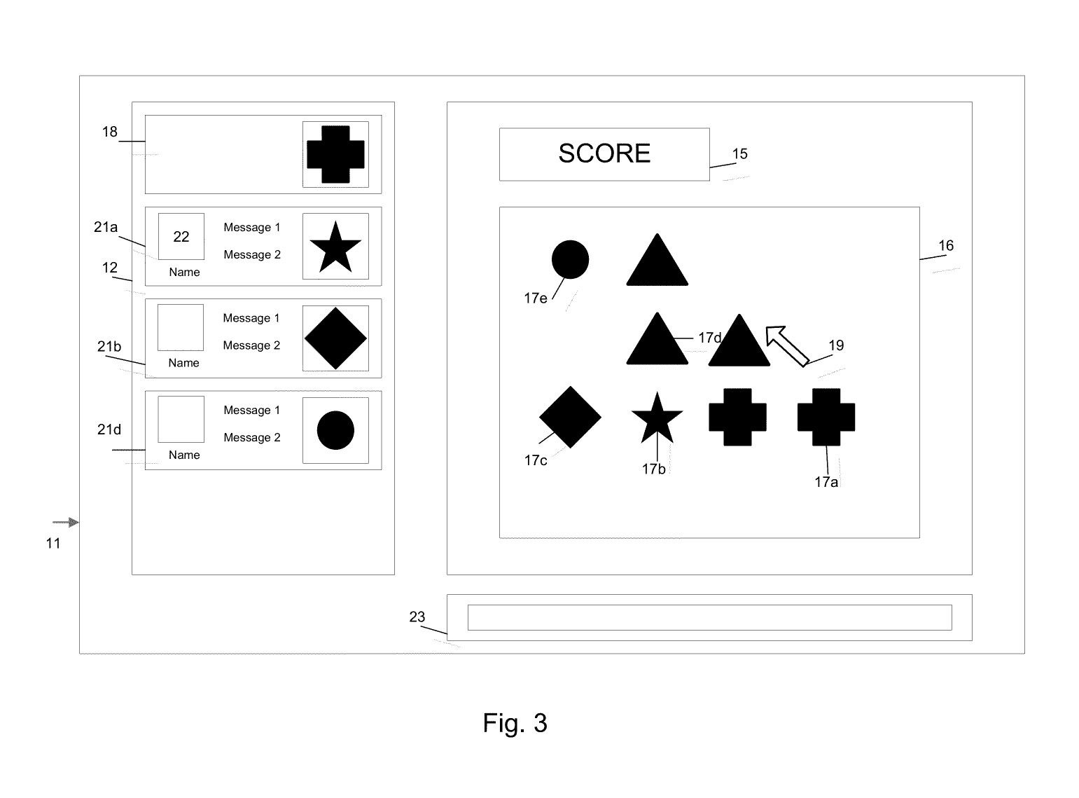

As shown in FIG. 3, the user has played the game tile of area 21c (e.g., similar to game tile 17d) and has placed it into the game board 16. In this example, the normal, next game tile is still provided in area 18, and may be selected by the user. Since the game tile from area 21c in the live board 12 has been played in the game board 16, this entry is removed from the live board 12, and the remaining available game tiles may be resorted, for example.

As indicated above, there are a variety of ways for friends of the user to provide assistance into the live board 12 of FIGS. 1-3. For example, a friend who achieves a particular score in the same or different game may be given the option of providing the assistance of a game element (e.g., a tile in the example of FIGS. 1-3) to another party. In such a case, the friend may select from a number of his/her friends that are playing the games described herein and select the user (i.e., the individual or group that is playing the game in FIGS. 1-3). The game element may be specific (e.g., providing the game tile 17d to user) or may be in the form of general assistance where the computer system selects the game element to be provided (e.g., randomly, based on the needs of the user in playing the game, etc.).

In addition to score, a friend may earn the ability to provide assistance in accordance with embodiments of the present invention by achieving a particular level in a game, completing a particular mission, time spent playing the game, having a particular number of friends sign up to play games on a particular social networking game website, etc. Also, the friend may pay for the ability to provide assistance (e.g., through game currency or real money value). Furthermore, the user's participation (as opposed to that of a friend) may lead to a friend providing assistance. For example, a user achieving a particular score or paying game or real money currency, may enable one of his/her friends to provided assistance in accordance with the embodiments of the present invention. Of course, any parameter(s) that allow a friend to provide assistance to a user may be applied to a user leading to giving a friend of the user the ability to provide assistance in the game.

As indicated above, the friend may provide assistance to the user as a gift. In an embodiment of the present invention, the user may request a gift from one or more or all friends of the user by typing such a request in text-entry space 23.

In one embodiment of the present invention, assistance provided by one or more friends of the user may be placed in the live board 12 of the user in substantially real time. Thus, as a friend earns and is given the ability to provide assistance to the user in the form of a game element, that element will be available in the live board 12 soon thereafter. Also, a friend may provide assistance before the user has started playing a game. In such a situation, the assistance in the live board 12 may be provided upon the user starting game play or at some point thereafter.

In the embodiments described above, the assistance provided in live board 12 is from a friend to the user. In one embodiment, the assistance provided to the user is not based on the actions of another participant and is instead provided by the backend application system (as described below). Accordingly, the assistance provided may be random, based on the needs of the user in playing the game, etc.

The assistance that is provided by the friend may be provided to others besides the user. For example, the assistance may be provided to all friends including the user for each to use. Alternatively, the assistance may be provided with some sort of limitation on it. For example, the assistance may be in the form of a game element provided to all friends including the user, but only if that assistance is used within a certain period of time. Alternatively, the assistance may be provided to all friends including the user, but only to the first set number of game players who use the offered assistance. As indicated above, the description of any limitations of the assistance being provided may be included in the live board 12 next to the game element being provided. In this example, once the set number of game players (e.g., 5) have accepted the provided assistance (e.g., by playing the game tile in his/her game board 16), the entry in the live board 12 for all users who initially received it will be removed.

In embodiments of the present invention described above, the assistance is provided by a participant to a user if that participant has met at least one requirement of at least one game parameter with respect to a game application. The frequency of the assistance may be anywhere from a rare occurrence to continuous. In one embodiment, game play by a user requires this assistance from one or more other participants. In the embodiments of FIGS. 1-3, the next game element of area 18 may be removed, and all game elements to be played by the user would be supplied by one or more participants (e.g., the social networking friends of the user). Also, the play of the user would lead to the assistance that is necessary for the other participants to play the game. As indicated above, the assistance may be specific in that a participant provides a specific game element to the user when he/she has earned the ability to do so (and possibly in response to a text message request by the user). Alternatively, the back application system selects the game element that is provided to the user (e.g., randomly). In this embodiment, there is a tight dependency between user's ability to play the game and the game elements provided to the user in the live board 12.

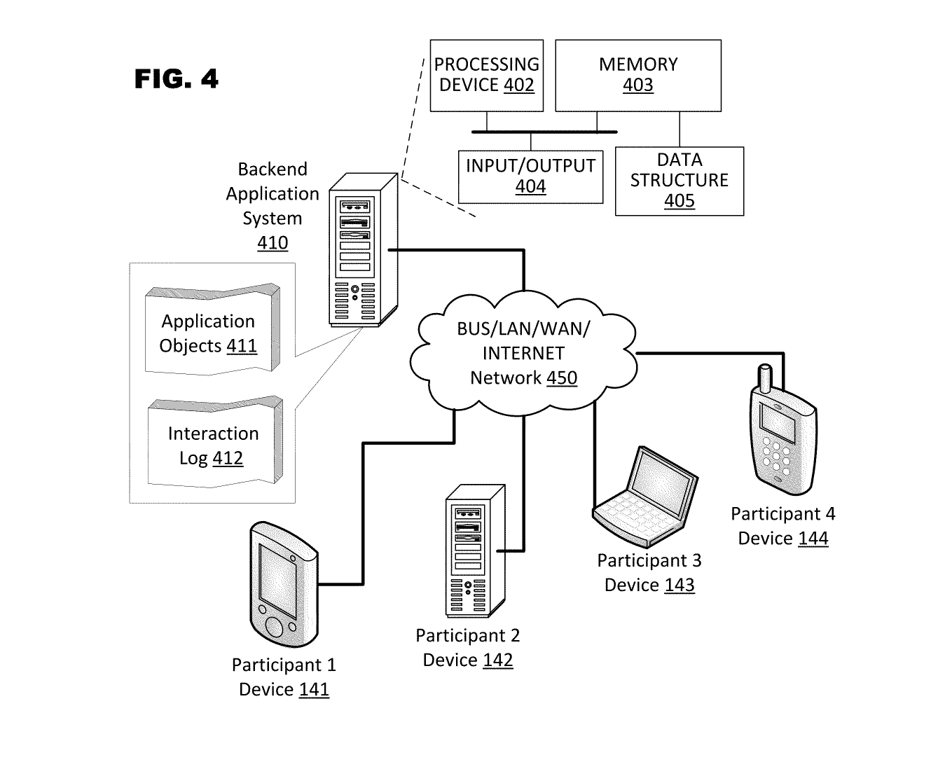

FIG. 4 shows an exemplary architecture in an embodiment of the present invention. Backend application system 410 may include a multi-participant application having a set of application objects 411 that the participants may be able to interact with. Backend application system 410 may also include an interaction log 412 for storing records of object interactions of different participants. These records may include a participant identifier, an interaction time, an object identifier, and a type of interaction identifier.

Backend application system 410 may be connected to a network 450. Network 450 may include a LAN, WAN, bus, or the Internet and may include connectivity through any transmission medium, including, but not limited to, wireless, optical, and radio. Each of the four participant devices 141 to 144 may also be connected to network 450 to communicate with the backend application system 410.

Backend application system 410 may interface with other systems and components. For example, a network/data storage device may be used to store the application objects 411 and/or interaction log 412. The storage device may contain a hard disk drive, flash memory, or other computer readable media capable of storing data.

Each of the systems 410 and devices 141 to 144 in FIG. 4 may contain a processing device 402, memory 403 storing loaded data or a loaded data structure 405, and a communications device 404, all of which may be interconnected via a system bus. In various embodiments, each of the systems and devices 410 and 141 to 144 may have an architecture with modular hardware and/or software systems that include additional and/or different systems communicating through one or more networks.

Communications device 404 may enable connectivity between the processing devices 402 in each of the systems and the network 450 by encoding data to be sent from the processing device 402 to another system or device over the network 450 and decoding data received from another system over the network 450 for the processing device 402.

In an embodiment, memory 403 may contain different components for retrieving, presenting, changing, and saving data. Memory 403 may include a variety of memory devices, for example, Dynamic Random Access Memory (DRAM), Static RAM (SRAM), flash memory, cache memory, and other memory devices. Additionally, for example, memory 403 and processing device(s) 402 may be distributed across several different computers that collectively comprise a system.

Processing device 402 may perform computation and control functions of a system and comprises a suitable central processing unit (CPU). Processing device 402 may include a single integrated circuit, such as a microprocessing device, or may include any suitable number of integrated circuit devices and/or circuit boards working in cooperation to accomplish the functions of a processing device. Processing device 402 may execute computer programs, such as object-oriented computer programs, within memory 403.

In the foregoing description, the user that is playing a game such as the game shown in FIGS. 1-3 may be playing that game on one of the participant devices 141-44. Friends of the user as described above may be playing the same or different game on any of a variety of other participant devices.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention.

We claim:

1. A method for providing assistance from a participant in a multi-participant gaming application comprising:
determining that a participant has met at least one requirement of at least one game parameter with respect to a game application;
if the participant has met said at least one requirement, providing a game element to a user in a display area associated with a game the user is currently playing and said user plays said game element in the game.

2. The method of claim 1, wherein a participant has met at least one requirement of at least one game parameter if the participant has achieved a threshold score with respect to the game application.
The method of claim 1, wherein a participant has met at least one requirement of at least one game parameter if the participant has achieved a threshold level with respect to the game application.

3. The method of claim 1, wherein a participant has met at least one requirement of at least one game parameter if the participant has achieved a threshold mission with respect to the game application.

4. The method of claim 1, wherein a participant has met at least one requirement of at least one game parameter if the participant has paid a sufficient amount of at least one of real and game currency.

5. The method of claim 1, wherein the participant is designated as a friend through a social networking application.

6. The method of claim 6 wherein multiple participants are designated as a friend through the social networking application.

7. The method of claim 7 wherein each participant designated as a friend of said user is associated with a provided game element in the display area associated with the game the user is currently playing.

8. A method for providing assistance from a participant in a multi-participant gaming application comprising:
determining that a participant has met at least one requirement of at least one game parameter with respect to a game application;
providing a first game element that a user is capable of playing in a game;
if the participant has met said at least one requirement, providing a second game element to the user in a display area associated with the game the user is currently playing; and
said user playing one of said first and second game elements in the game.

9. The method of claim 9, wherein the participant is designated as a friend through a social networking application.

10. The method of claim 10 wherein multiple participants are designated as a friend through the social networking application.

11. The method of claim 11 wherein each participant designated as a friend of said user is associated with a provided game element in the display area associated with the game the user is currently playing.

12. A device comprising a computer readable medium including instructions that, when executed by a processing device, cause the processing device to:
determine that a participant has met at least one requirement of at least one game parameter with respect to a game application;
if the participant has met said at least one requirement, provide a game element to a user in a display area associated with a game the user is currently playing and said user plays said game element in the game.

13. A multi-participant gaming system comprising:
a processing device executing a multi-participant gaming application;
a network interface connecting the processing device to a communications network to which computing devices of a plurality of gaming participants are connected; wherein
the processing device determines that a participant has met at least one requirement of at least one game parameter with respect to a game application;
if the participant has met said at least one requirement, the processing devices provides a game element to a user in a display area associated with a game the user is currently playing and said user plays said game element in the game.
